(19) United States
(12) Patent Application Publication
(10) Pub. No.: US 2014/0247349 A1
(43) Pub. Date: Sep. 4, 2014

(54) INTEGRATED LIGHTING, CAMERA AND SENSOR UNIT

(71) Applicant: GM GLOBAL TECHNOLOGY OPERATIONS LLC, Detroit, MI (US)

(72) Inventor: Charles H. Heard, Farmington Hills, MI (US)

(73) Assignee: GM GLOBAL TECHNOLOGY OPERATIONS LLC, Detroit, MI (US)

(21) Appl. No.: 13/784,375

(22) Filed: Mar. 4, 2013

(51) Int. Cl. H04N 7/18

(52) U.S. Cl. CPC H04N 7/18
USPC 348/148

(57) ABSTRACT

In one exemplary embodiment of the invention, an integrated assembly for a vehicle includes a body, a light and a sensor configured to detect objects proximate the integrated assembly. The assembly also includes a camera, wherein the light, sensor and camera are housed by the body within the integrated assembly. The assembly includes a connector on the body to provide signal communication with the light, sensor and camera.

### FIELD OF THE INVENTION

The subject invention relates to a lighting, camera and sensor unit. Specifically, the disclosure relates to an integrated lighting, camera and sensor unit for installation on a vehicle.

### BACKGROUND

Sensor units may be used on vehicles to identify when objects are in close proximity to front or rear fascias of the vehicles. In some cases, an audible sound may alert an operator when an object is detected proximate the vehicle, such as during parking of the vehicle. In some cases, a plurality of sensors are positioned across the fascia to detect objects proximate all portions of the front or rear of the vehicle. Manufacturing, assembling and replacing these sensors can be time consuming and costly due to the wiring and positioning required for each of the sensor units.

### SUMMARY OF THE INVENTION

In one exemplary embodiment of the invention, an integrated assembly for a vehicle includes a body, a light and a sensor configured to detect objects proximate the integrated assembly. The assembly also includes a camera, wherein the light, sensor and camera are housed by the body within the integrated assembly. The assembly includes a connector on the body to provide signal communication with the light, sensor and camera.

In another exemplary embodiment of the invention an integrated assembly for a vehicle fascia includes a light, a sensor configured to detect objects proximate the integrated assembly, a camera and a shell, wherein the light, sensor and camera are positioned within the shell. The assembly also includes a connector configured to provide signal communication with the light, sensor and camera.

In yet another exemplary embodiment of the invention, a vehicle includes a fascia and an integrated assembly located in the fascia. The integrated assembly includes a body, a light, a sensor configured to detect objects proximate the integrated assembly and a camera, wherein the light, sensor and camera are housed by the body within the integrated assembly. A connector on the body provides signal communication with the light, sensor and camera.

The above features and advantage and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic illustration of a vehicle according to an embodiment;

FIG. 2 is a side sectional view of a portion of an integrated assembly that includes a light, a sensor and a camera according to an embodiment;

FIG. 3 is a side sectional view of a portion of an integrated assembly that includes a light, a first sensor, a camera and a second sensor according to an embodiment;

FIG. 4 is a perspective view of an integrated assembly according to an embodiment; and

FIG. 5 is a perspective view of an integrated assembly according to another embodiment.

### DESCRIPTION OF THE EMBODIMENTS

The following description is merely exemplary in nature and is not intended to limit the present disclosure, its application or uses. As used herein, the terms controller and module refer to an application specific integrated circuit (ASIC), an electronic circuit, a processor (shared, dedicated, or group) and memory that executes one or more software or firmware programs, a combinational logic circuit, and/or other suitable components that provide the described functionality. In embodiments, a controller or module may include one or more sub-controllers or sub-modules.

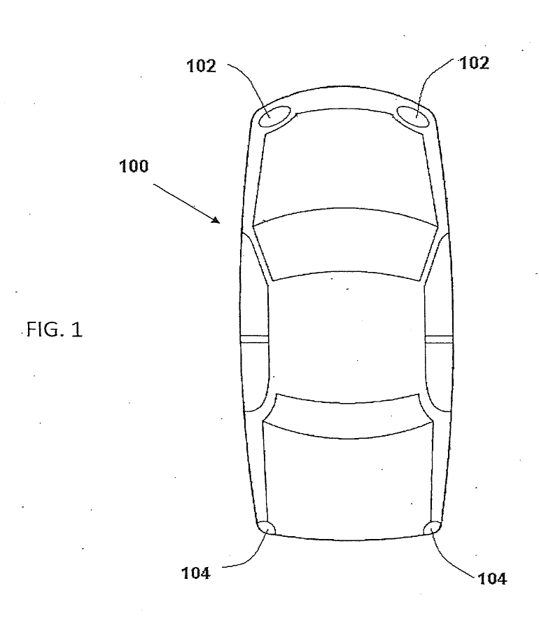

In accordance with an exemplary embodiment of the invention, FIG. 1 illustrates a vehicle 100. The vehicle 100 includes a pair of light assemblies 102 positioned on a front fascia of the vehicle 100. The light assemblies 102 may be include headlights to provide visibility in low light conditions. In an embodiment, the light assemblies may include turn signal lights. The vehicle 100 also includes a pair of light assemblies 104 positioned on a rear fascia of the vehicle 100. The light assemblies 104 may be assemblies that include taillights and/or turn signal lights. In embodiments, the light assemblies 102, 104 may each include a plurality of lights. In an embodiment, the light assemblies 102, 104 are integrated assemblies that include a light, sensor and camera within a shell of the assemblies. As described in detail below, embodiments the light assemblies 102, 104 include a body that houses a light, sensor and camera, wherein the body provides an integrated assembly. The body also includes a single connector that provides power and communication signals to and from each of the light, sensor and camera. Accordingly, the integrated light, sensor and camera within the light assemblies 102, 104 provide simplified installation and connectivity to the light, sensor and camera located therein.

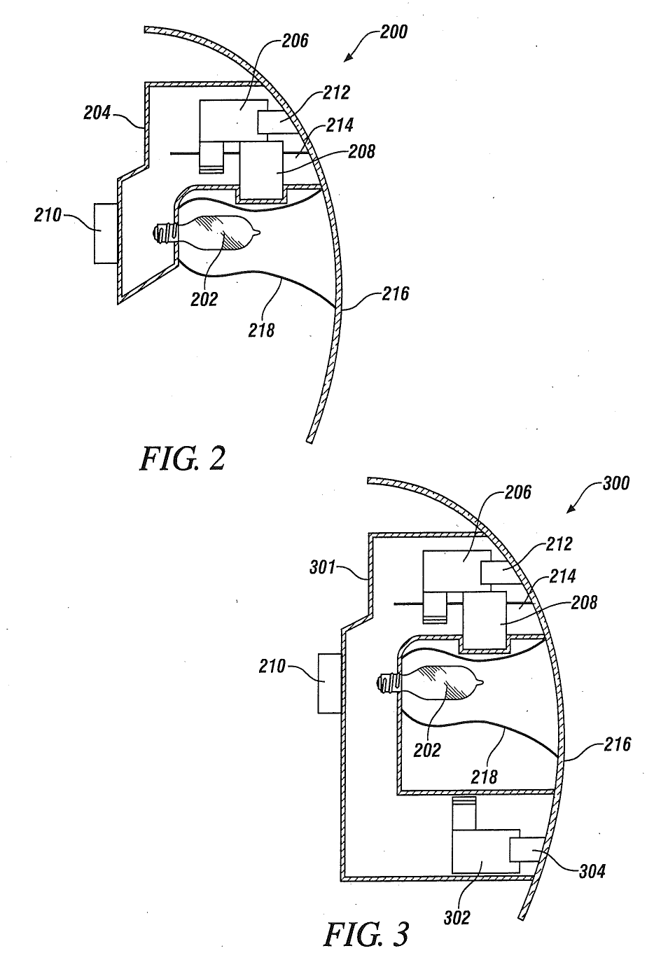

FIG. 2 is a side sectional view of a portion of an integrated assembly 200 that includes a light 202, a sensor 206 and a camera 208 according to an embodiment. In embodiments, the integrated assembly 200 is installed on a front fascia or rear fascia of a vehicle, such as the light assemblies 102, 104 illustrated in FIG. 1. A body 204 houses the light 202, the sensor 206 and the camera 208. In an aspect, the integrated assembly 200 includes a shell 216 that is substantially transparent to allow communication of light emitted by the light 202 through the shell 216. In addition, the shell 216 is transparent to allow images to be acquired by the camera 208. In an embodiment, the shell 216 is a lightweight, durable and formable material such as, but not limited to, a thermoplastic, thermosetting polymer or glass.

In embodiments, the shell 216 is composed of a suitable material and thickness to allow the sensor 206 to detect objects that are proximate the integrated assembly 200. In embodiments, the sensor 206 may be any suitable proximity sensor including, but not limited to, the following sensor types: capacitive, capacitive displacement sensor, Doppler-effect (i.e., sensor based on the effect), eddy-current, inductive, laser rangefinder, magnetic (including magnetic proximity fuse), passive optical (e.g., charge-coupled devices), passive thermal infrared, photocell (reflective), radar, sonar (active or passive) and ultrasonic. In an exemplary embodiment, the sensor 206 is an ultrasonic sensor that emits and detects sonic waves, where the sonic waves are reflected when an object is proximate the sensor 206. In another embodiment, the sensor 206 is a laser rangefinder-type sensor that sends a laser pulse in a narrow beam towards an object and measures the time taken by the pulse to be reflected off the object and returned to the sensor 206. The sensor 206 may also use a Doppler effect to determine if the object is moving relative to the integrated assembly 200. The sensor 206 may be used for a variety of applications, such as for parking assistance or for adaptive cruise control, where the sensor 206 determines a location of a vehicle relative to the integrated assembly to maintain a selected distance between the vehicles. The camera 208 may be used for any suitable purpose, such as for parking assistance (e.g., back-up camera), to provide blind spot visibility for vehicles or to provide night vision images.

In an embodiment, a face 212 of the sensor 206 abuts the shell 216. In another embodiment, the face 212 is recessed from the shell 216 (not shown). Similarly, in one embodiment, a face 214 of the camera 208 abuts the shell 216. In another embodiment, the face 214 is recessed from the shell 216 (not shown). Regardless of the positioning of the sensor face 212 and the camera face 214, the body 204 provides a substantially protected environment within the integrated assembly 200 by substantially sealing against the shell 216 to enclose the sensor 206 and camera 208. An exemplary ultrasonic sensor 206 is a sealed sensor unit that is not affected by moisture around or on the face 212 of the sensor. In embodiments, a guide 218 may extend from or be a portion of the body 204 to direct and reflect light waves emitted by the light 202 as the waves travel to the shell 216. The guide 218 also provides a substantially protected environment for the light 202. By providing a protected environment for the light 202, sensor 206 and camera 208, the protected devices are insulated from exposure to dirt, debris, moisture and other factors that may adversely affect operation of the light 202, sensor 206 and camera 208. In an embodiment, the camera 208 is positioned between the light 202 and sensor 206. In other embodiments, the sensor 206 is positioned between the light 202 and camera 208. As depicted, the body 204 also includes a connector 210 that provides communication for signals and power to the light 202, sensor 206 and camera 208 in a single input or coupling. The connector 210 provides simplified wiring and assembly to reduce cost while simplifying repair and manufacturing processes. In other embodiments where the light, sensor and camera are separate assemblies on a fascia, separate wiring harnesses are required to provide signals to each assembly, where each assembly has a connector or plug. In contrast, an embodiment of the connector 210 connects to a single wiring harness that provides signals that are communicated to and from the light 202, sensor 206 and camera 208, thus simplifying the assembly and process.

FIG. 3 is a side sectional view of a portion of an integrated assembly 300 that includes the light 202, the first sensor 206, the camera 208 and a second sensor 302 according to an embodiment. In embodiments, the integrated assembly 300 is to be installed on a front fascia or rear fascia, such as those illustrated in FIG. 1. A body 301 houses the light 202, the first sensor 206, the second sensor 302 and the camera 208. In an aspect, the integrated assembly 300 includes the shell 216 that is substantially transparent and formed from a lightweight and durable material. As depicted, the body 301 houses the proximity sensors 206 and 302, which are positioned in separate parts of the integrated assembly 300. In an embodiment, a face 304 of the sensor 302 abuts the shell 216. In another embodiment, the face 304 is recessed from the shell 216. As described above, the body 301 provides a substantially protected environment for the first sensor 206, the camera 208, the light 202 and the second sensor 302. The proximity sensors are positioned apart within the integrated assembly 300 to detect objects across a range of locations proximate the integrated assembly 300. In embodiments, two integrated assemblies 300 are positioned on a fascia where the proximity sensors 206 and 302 within each assembly detect objects across the entire fascia of the vehicle.

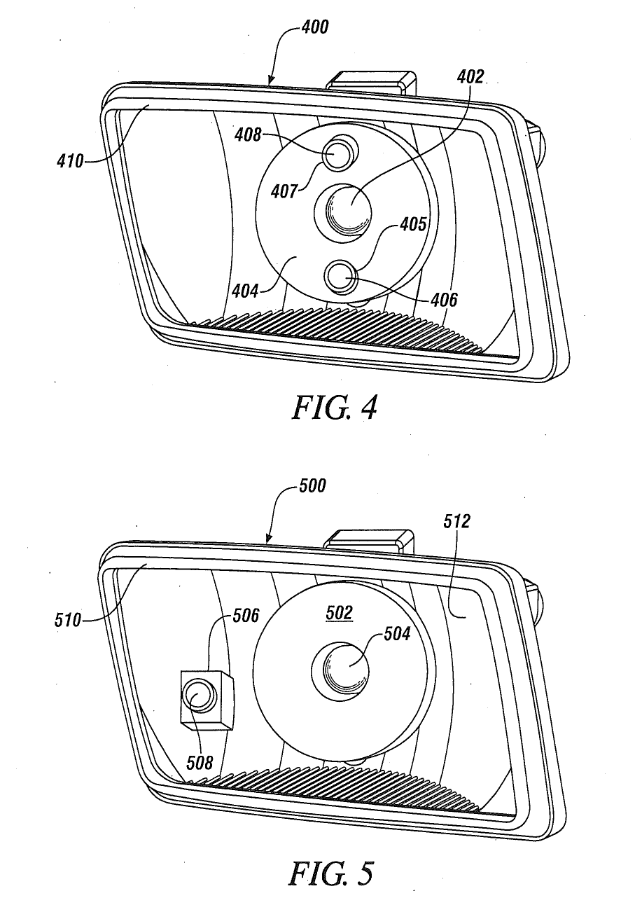

FIG. 4 is perspective view of an integrated assembly 400 that includes a light 402, a sensor 405 and a camera 407 according to an embodiment. In embodiments, the integrated assembly 400 is installed on a front fascia or rear fascia, such as the light assemblies 102, 104 illustrated in FIG. 1. A body 404 houses the light 402, the sensor 405 and the camera 407. In an aspect, the integrated assembly 400 includes a shell 410 that is substantially transparent to allow communication of light emitted by the light 402 through the shell 410. In addition, the shell 410 is transparent to allow images to be acquired by the camera 407. In embodiments, the shell 410 is formed from a lightweight and durable material, such as a thermoplastic. In an embodiment, a face 406 of the sensor 405 abuts the shell 410. In another embodiment, the face 406 is recessed from the shell 410. Similarly, a face 408 of the camera 407 abuts the shell 410. In another embodiment, the face 408 is recessed from the shell 410. As described above, the body 404 provides a substantially protected environment for the sensor 405, the camera 407 and the light 402. As depicted, the light 402 is positioned between the sensor 405 and the camera 407.

FIG. 5 is a perspective view of an integrated assembly 500 that includes a light 502, a sensor 506 and a camera 504 according to an embodiment. In embodiments, the integrated assembly 500 is to be installed on a front fascia or rear fascia, such as the light assemblies 102, 104 illustrated in FIG. 1. A body 512 is integrated into an internal shell of the assembly, where the body 512 houses the light 502, the sensor 506 and the camera 504. In an aspect, the integrated assembly 500 includes a shell 510 that is substantially transparent to allow communication of light from the light 502 through the shell 510. In addition, the shell 510 is transparent to allow images to be acquired by the camera 504. In embodiments, the shell 510 is formed from a lightweight and durable material, such as a thermoplastic, thermosetting polymer or glass. In an embodiment, a face 508 of the sensor 506 abuts the shell 510. In another embodiment, the face 508 is recessed from the shell 510. As depicted, the camera 504 is positioned within the light 502, where the light 502 provides illumination for images acquired by the camera 504. As depicted he sensor 506 is a proximity sensor positioned apart from the light 502 and camera 504. The sensor 506 and the sensor 405 (FIG. 4) are proximity sensors, such as those described in FIGS. 2 and 3.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An integrated assembly for a vehicle, the integrated assembly comprising:
a body;
a light;
a sensor configured to detect objects proximate the integrated assembly;
a camera, wherein the light, sensor and camera are housed by the body within the integrated assembly; and
a connector on the body to provide signal communication with the light, sensor and camera.

2. The integrated assembly of claim 1, further comprising a shell, wherein the body, light, sensor and camera are positioned within the shell in an interior portion of the integrated assembly.

3. The integrated assembly of claim 2, wherein the sensor comprises a sensor face substantially abutting an interior surface of the shell.

4. The integrated assembly of claim 1, wherein the camera is positioned between the sensor and light in the body.

5. The integrated assembly of claim 1, wherein the connector provides communication of all power and signals to the light, sensor and camera.

6. The integrated assembly of claim 1, wherein the integrated light assembly is configured to be installed on a front fascia or rear fascia of a vehicle.

7. The integrated assembly of claim 1, wherein the sensor comprises one of an ultrasonic proximity sensor or a laser proximity sensor.

8. The integrated assembly of claim 1, wherein the body provides a protected environment for the sensor and camera within the integrated assembly.

9. An integrated assembly for a vehicle fascia, the integrated assembly comprising:
a light;
a sensor configured to detect objects proximate the integrated assembly;
a camera;
a shell, wherein the light, sensor and camera are positioned within the shell; and
a connector configured to provide signal communication with the light, sensor and camera.

10. The integrated assembly of claim 9, wherein the shell comprises a substantially translucent shell.

11. The integrated assembly of claim 9, further comprising a body housing the light, sensor and camera.

12. The integrated assembly of claim 9, wherein the sensor comprises a sensor face substantially abutting an interior surface of the shell.

13. The integrated assembly of claim 9, wherein the camera is positioned between the sensor and light.

14. The integrated assembly of claim 9, wherein the connector provides communication of all power and signals to the light, sensor and camera.

15. The integrated assembly of claim 9, wherein the sensor comprises one of an ultrasonic proximity sensor or a laser proximity sensor.

16. The integrated assembly of claim 9, wherein the body provides a protected environment for the sensor and camera within the integrated assembly.

17. A vehicle comprising:
a fascia; and
an integrated assembly located in the fascia, the integrated assembly comprising:
a body;
a light;
a sensor configured to detect objects proximate the integrated assembly;
a camera, wherein the light, sensor and camera are housed by the body within the integrated assembly; and
a connector on the body to provide signal communication with the light, sensor and camera.

18. The vehicle of claim 17, further comprising a shell, wherein the body, light, sensor and camera are positioned within the shell in an interior portion of the integrated assembly.

19. The vehicle of claim 17, wherein the camera is positioned between the sensor and light.

20. The vehicle of claim 17, wherein the body provides a protected environment for the sensor and camera within the integrated assembly.
